(19) United States
(12) Patent Application Publication
(10) Pub. No.: US 2009/0030728 A1
(43) Pub. Date: Jan. 29, 2009

(54) MEDICAL SAFETY SYSTEM

(76) Inventors: Toshiaki Nakazato, Nasushiobara-shi (JP); Satoshi Ikeda, Yaita-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/176,442

(22) Filed: Jul. 21, 2008

(30) Foreign Application Priority Data
Jul. 23, 2007 (JP) 2007-191367

(51) Int. Cl. G06Q 50/00; G06F 17/30

(52) U.S. Cl. 705/3; 707/104.1; 707/E17.008

(57) ABSTRACT

An action storage unit stores medical action information including at least information about the instructor of a medical action, an instruction from the instructor, an executor who has executed an action in accordance with the instruction, and the action executed by the executor. A singular point extraction unit extracts information singular to a predetermined analysis target by statistically analyzing the predetermined analysis target of the medical action information. A report creation unit creates a report including at least an analysis result on the analysis target on the basis of the extracted singular information.

### CROSS-REFERENCE TO RELATED APPLICATIONS

This application is based upon and claims the benefit of priority from prior Japanese Patent Application No. 2007-191367, filed Jul. 23, 2007, the entire contents of which are incorporated herein by reference.

### BACKGROUND OF THE INVENTION

1. Field of the Invention

The present invention relates to a medical safety system.

2. Description of the Related Art

There have been reported medical accidents due to ambiguous instructions and erroneous instructions from doctors to medical staff. In order to prevent such medical accidents, a prescription monitoring system which checks whether prescriptions for patients are correct has been proposed (see Jpn. Pat. Appln. KOKAI Publication No. 6-78885). There has also been proposed a step warning apparatus which generates a warning to an object such as a doctor or a nurse when there is an error about the place where he/she is performing an operation or an error in the progress (see Jpn. Pat. Appln. KOKAI Publication No. 2005-92440).

The prescription monitoring system disclosed in patent reference 1 described above has registered, in advance, OK information which is information indicating that the system has made a question inquiry about prescription contents for a specific patient to a doctor and has obtained, from the doctor, a consent that the prescription will be valid for a predetermined period of time in the future, or information indicating that a pharmacist has determined under his/her functional responsibility that the prescription will be valid for a predetermined period of time in the future, and has given a consent to administer the medicine to the patient. The prescription monitoring system monitors whether an input prescription is OK. Upon finding a result which should attract a warning as a result of monitoring, the prescription monitoring system searches the pre-registered OK information for OK information corresponding to the type of warning. If corresponding OK information exists, the prescription monitoring system outputs confirmation information as a check result. If no corresponding OK information exists, the prescription monitoring system outputs warning information as a check result.

The warning apparatus disclosed in patent reference 2 recognizes the locations of objects such as a doctor, a nurse, and a worker, and also generates warnings corresponding to the behaviors of objects. More specifically, the warning apparatus records and analyzes the behavior of an object which performs a specific operation, and generates a warning as needed. An identification information detection means (a station in the embodiments) is placed at a predetermined position in an area where a given object performs a specific operation (for example, in a building), and detects object identification information (a nurse ID in the embodiments) assigned to the object. A location detection means detects at least the location of an object based on the detection result of the identification information detection means. That is, this means detects the position of the object on the basis of the placement position of the identification information detection means which has detected the object. An operation specifying means specifies the content of an operation to be performed by an object. For example, this means specifies “injection”, “temperature taking”, or the like as the content of a nursing operation to be performed by an object (nurse). A progress detection means detects the location of an object and the progress of an operation specified by the operation specifying means. In this case, this means detects the place where the object is performing an operation and the progress of the operation. If a status discrimination means discriminates that there is an error about the place where the object is performing an operation or the progress of the operation, a warning means generates a warning to at least the object.

In general, however, in a medical institution, medical information systems from different vendors are in service. In the present circumstances, there is no practice of cross-analyzing the respective types of information systems and analyzing an unsafe status in a medical site.

### BRIEF SUMMARY OF THE INVENTION

It is an object of the present invention to provide a system which can find an event which causes a medical accident before the actual occurrence of a medical accident and prevent the occurrence of a medical accident.

A medical safety system according to claim 1 of the present invention, comprising: a first storage unit which stores medical action information including at least information about an instructor of a medical action, an instruction from the instructor, an executor who has executed an action in accordance with the instruction, and the action executed by the executor; a first extraction unit which extracts information singular to a predetermined analysis target of the medical action information by statistically analyzing the predetermined analysis target; and a creation unit which creates a report including at least an analysis result and the analysis target on the basis of the extracted singular information.

A medical safety system according to claim 14 of the present invention, comprising: an input unit which inputs a plurality of records each including information about an instructor of a medical action, an instruction from the instructor, an executor who has executed an action in accordance with the instruction, and the action executed by the executor; a counting unit which counts the number of records, of the plurality of input records, which concern a predetermined instructor and a predetermined instruction, for each type of the action; an extraction unit which extracts statistically significant information about the predetermined instructor and the predetermined instruction by statistically analyzing the counted number of records; and a creation unit which creates a report concerning the extracted significant information.

A medical safety system according to claim 15 of the present invention, comprising: an input unit which inputs a plurality of records each including information about an instructor of a medical action, an instruction from the instructor, an executor who has executed an action in accordance with the instruction, and the action executed by the executor; a storage unit which stores a score table which associates an action of an executor with a score indicating a degree of abnormality of the action; a calculation unit which calculates a plurality of integrated values by integrating a plurality of scores associated with actions of a plurality of records, of the plurality of input records, which concern a predetermined instructor and a predetermined instruction, on the score table, for the respective types of actions; an extraction unit which extracts statistically significant information about the predetermined instructor and the predetermined instruction by statistically analyzing the plurality of calculated integrated values; and a creation unit which creates a report concerning the extracted significant information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the relationship between a medical safety system according to the first embodiment of the present invention and other systems;

FIG. 2 is a view showing a prescription window example in a prescription system in FIG. 1;

FIG. 3 is a view showing a clinical chart window example in a clinical chart system when a clinical chart reference button in FIG. 2 is pressed;

FIG. 4 is a block diagram showing the schematic arrangement of a medical safety system according to the first embodiment of the present invention;

FIG. 5 is a view showing an example of data items stored in an action table in FIG. 4;

FIG. 6 is a view showing an example of how a report is created by using assumed frequencies;

FIG. 7 is a view showing an example of a score table according to the second embodiment of the present invention;

FIG. 8 is a graph showing the integrated values of scores obtained when a clinical chart check at the time of the execution of an order and a clinical chart check after the execution of the order are each made twice;

FIG. 9 is a block diagram showing the schematic arrangement of a medical safety system according to the third embodiment of the present invention;

FIG. 10 is a view showing an example of assumed frequencies stored in an action assumed frequency storage unit in FIG. 9;

FIG. 11 is a view showing an example of how a report is created by using the assumed frequencies in FIG. 10;

FIG. 12 is a view showing a case in which treatment phases are stored in the action assumed frequency storage;

FIG. 13 is a view showing a case in which disease codes are stored in the action assumed frequency storage;

FIG. 14 is a block diagram showing the schematic arrangement of a medical safety system according to the fourth embodiment of the present invention;

FIG. 15 is a view showing an example of an action extraction condition table;

FIG. 16 is a block diagram showing the schematic arrangement of a medical safety system according to the fifth embodiment of the present invention;

FIG. 17 is a view showing a question report window example; and

FIG. 18 is a block diagram showing the schematic arrangement of a medical safety system according to the sixth embodiment of the present invention.

### DETAILED DESCRIPTION OF THE INVENTION

The embodiments of the present invention will be described below with reference to the views of the accompanying drawing.

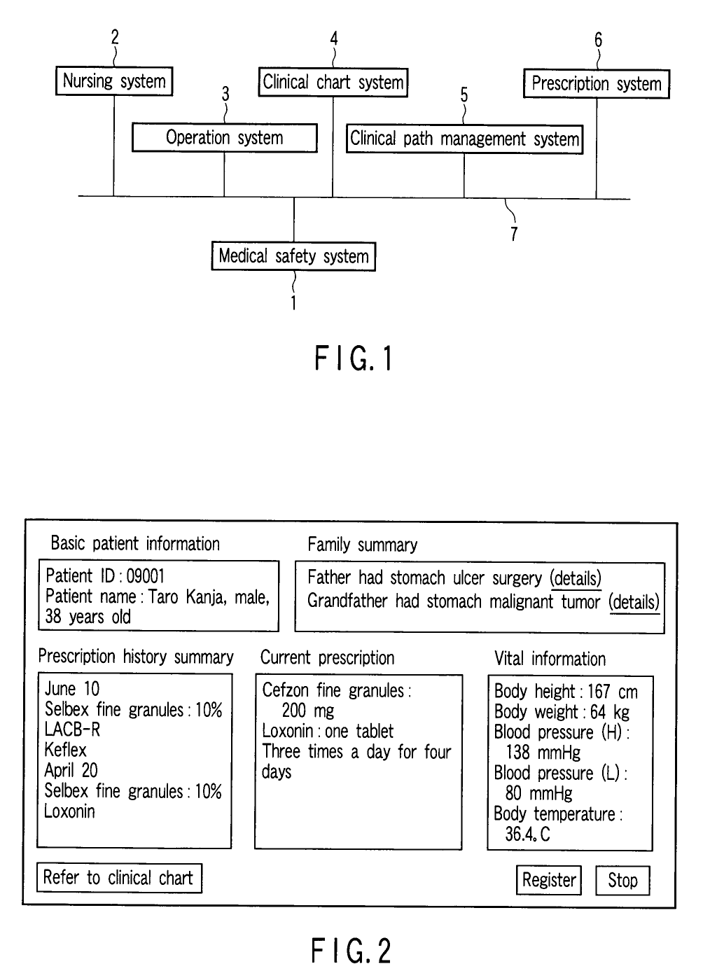

FIG. 1 is a block diagram showing the relationship between a medical safety system according to an embodiment of the present invention and other systems. As shown in FIG. 1, a medical safety system 1 according to an embodiment of the present invention, a nursing system 2, an operation system 3, a clinical chart system 4, a clinical path management system 5, and a prescription system 6 are connected to each other via a computer network 7. This embodiment acquires operation information of each system directly, indirectly, automatically, or manually from each system. This embodiment creates a report containing objective indexes, thereby warns of an unsafe status in a medical institution.

The general characteristics of each system excluding the medical safety system according to this embodiment will be described below.

### (1) Nursing System 2

The nursing system 2 is a system mainly used by nurses. The nursing system 2 is a system which allows reference/registration to/of treatment instructions from a doctor, records corresponding to treatment instructions, messages to be shared among nurses, and patient vital information (e.g., body temperatures and blood pressures).

Treatment instructions from doctors include, for example, the names of medicines to be administered by drip infusion, drip infusion methods, and drip infusion start times. Nurses refer to these treatment instructions and perform treatments in accordance with the instructions. The nurses then input treatment results. The inputted treatment results are recorded in the system.

### (2) Operation System 3

The operation system 3 is a system which allows registration of and reference to operation preparation items, operation plans, and operation execution records.

“Operation preparation item” includes medicines, surgical instruments, bloods, and the like. A doctor registers operation preparation items in advance. A nurse prepares for an operation by referring to the registered operation preparation items.

“Operation plan” allows registration and referral to information such as techniques and operation region information.

“Operation execution record” includes records of surgery along the time axis from the start of the operation to the end of the operation. This manages, for example, information indicating which medicine has been administered from what hour and minute.

### (3) Clinical Chart System 4

The clinical chart system 4 is a system which records disease names, past histories, family medical histories, chief complaints, observation results, treatments, and the like. The clinical chart system 4 can display the information obtained by each associated system.

### (4) Clinical Path Management System 5

The clinical path management system 5 is a system which displays a nursing/medical treatment plan in a hospitalization.

For example, the clinical path management system 5 divides a hospitalization into a plurality of phases (e.g., a pre-operation phase, a current operation phase, a recovery phase, and a hospital discharge preparation phase), and manages a nursing plan in each phase and the like.

### (5) Prescription System 6

The prescription system 6 is a system which can display and register a disease name, medication contraindication, a prescription medicine name, a prescription dosage, an administration method, a prescription result, and the like. That is, the prescription system 6 allows referral to past prescription histories and currently prescribed medicines.

The prescription system 6 also allows referral to the clinical chart system 4.

FIG. 2 shows a prescription window example in the prescription system 6. The window example shown in FIG. 2 includes, as information display areas, a basic patient information area, a family summary area, a prescription history summary area, a current prescription area, and a vital information area. In the window example in FIG. 2, a clinical chart reference button, a registration button, and a stop button are displayed as buttons (icons) for operation. Each area displayed in FIG. 2 will be briefly described below.
(1) Basic patient information area: The basic patient information area is an area in which patient identification information (ID), patient name, sex, age, and the like are displayed. In this case, a patient ID and a patient name are displayed.
(2) Family summary area: The family summary area is an area in which family past history information is displayed. In this case, a past history concerning the stomach diseases of a father and grandfather is displayed.
(3) Prescription history summary area: The prescription history summary area is an area in which a past prescription history summary is displayed. In this case, a prescription date and a medicine name are displayed.
(4) Current prescription area: The current prescription area is an area in which the prescription currently instructed by a doctor is displayed. A pharmacist prescribes medicines by referring to this information. In order to check a prescribed medicine, for example, a check box on the left of a medicine name (not shown) is checked. The execution of a prescription instruction is ended by pressing the registration button. Note that the time point when information such as the ID card of a pharmacist is read can be regarded as the end of prescription.
(5) Vital information area: The vital information area is an area in which the vital information (body height, body weight, blood pressure, body temperature, and the like) registered by the doctor at the time of prescription is displayed. Note that if there is no current information, past vital information is displayed as reference information.

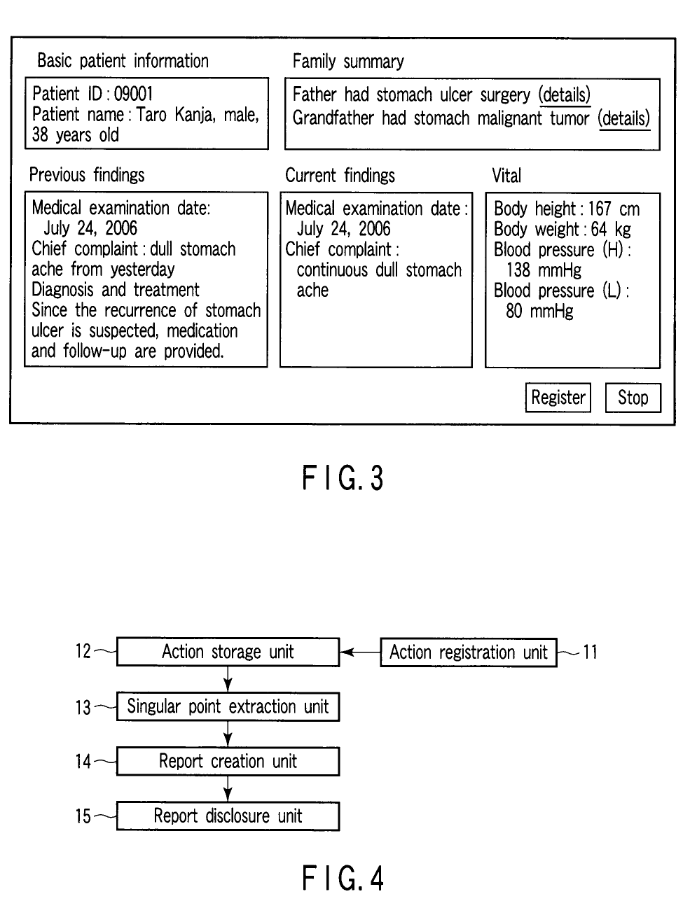

FIG. 3 is a view showing a clinical chart window example in the clinical chart system 4 when the clinical chart reference button in FIG. 2 is pressed. The window example in FIG. 3 includes, as information display areas, a basic patient information area, a family summary area, a previous findings area, a current findings area, and a vital area. In addition, in the window example in FIG. 3, a registration button and a stop button are displayed as buttons (icons) for operation. Each area displayed in FIG. 3 will be briefly described below.
(1) Basic patient information area: This area is the same as that shown in FIG. 2.
(2) Previous findings area: The previous findings area is an area in which previous consultation information is displayed. The contents to be displayed include a medical examination date, a chief complaint, a diagnosis, a treatment, and the like.
(3) Current findings area: The current findings area is an area in which current consultation information is displayed. The contents to be displayed include a medical examination date, a chief complaint, a diagnosis, a treatment, and the like.
(4) Vital area: This area is the same as that in FIG. 2.
(5) Family summary area: This area is the same as that in FIG. 2, in which the family disease history data acquired from an external system is displayed. When (details) is clicked, a detailed data check window (not shown) is activated.

A concrete prescription example will be briefly described. A pharmacist performs prescribing operation by referring to a prescription window like that shown in FIG. 2, as described above. Under normal circumstances, the pharmacist may perform prescribing operation by referring to only a prescription window. According to the past prescription displayed in the prescription window, a stomach medicine (Selbex fine granules) is prescribed. According to the current prescription, although an antiphlogistic analgesic (Loxonin) is prescribed, no medicine is prescribed for the stomach. This family summary contains the description of stomach diseases in the family. In this case, the pharmacist has a question about why no medicine is prescribed for the stomach. Having a question, the pharmacist presses “clinical chart reference button” which is not used under ordinary circumstances. When “clinical chart reference button” is pressed, a clinical chart is displayed. The pharmacist checks the actual medical examination contents by referring to the displayed clinical chart. The pharmacist then makes a question inquiry to the doctor with a telephone or the like. If there is any omission or error in the prescription contents, the doctor makes a prescription again. The specific embodiments of the present invention will be described below.

### First Embodiment

FIG. 4 is a block diagram showing the schematic arrangement of a medical safety system according to the first embodiment of the present invention. The medical safety system according to the first embodiment comprises an action registration unit 11, an action storage unit 12, a singular point extraction unit 13, a report creation unit 14, and a report disclosure unit 15.

The action registration unit 11 registers each item in the action storage unit 12. These data items are registered as medical action information. More specifically, the data items contained in an operation log (log file) in each information system are registered as medical action information. Medical action information includes at least information about an instructor of a medical action, an instruction from the instructor, an executor who has executed an action in accordance with an instruction item, and the action of the executor.

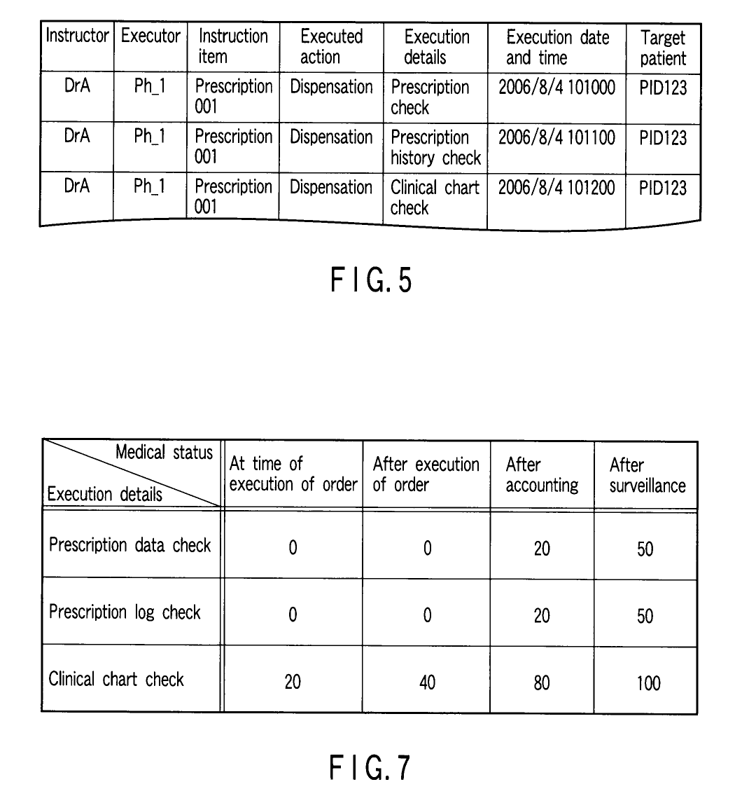

The action storage unit 12 sequentially stores medical action information (each data item) input from the action registration unit 11. FIG. 5 shows an example of medical action information to be stored. FIG. 5 shows an example of how medical action information is recorded when an executor Ph_1 performs a prescribing action in accordance with an instruction from an instructor DrA. Medical action information is sequentially stored on a record basis.

More specifically, “instructor” is a medical professional who has issued an instruction. In general, an instructor is often a doctor. As an instructor, a code or the like which uniquely identifies a doctor is registered. “Executor” is a medical professional who has executed the instruction. As an executor, a code which uniquely identifies the executor is registered. If, for example, a prescription instruction is issued, the executor is a pharmacist, and his/her personnel ID is registered. “Instruction item” is the content of an instruction from the instructor. It suffices to register a code which identifies the type of instruction in this field. “Execution action” is the content of an action corresponding to an instruction item. As an execution action, a large action classification can be stored. In this case, since dispensation is performed in accordance with a prescription instruction, dispensation is stored as an action classification. “Execution details” describes the details of an execution action. If, for example, a pharmacist has checked the content of a prescription, a prescription history, and a clinical chart to perform dispensation, all pieces of information representing the corresponding action classifications are stored. “Execution date” is the date when the executor has executed execution details. As “target patient” is a patient who has been performed an action. As a target patient, a code which uniquely identifies the patient is registered.

The singular point extraction unit 13 statistically analyzes a plurality of pieces of medical action information stored in the action storage unit 12, and extracts information singular to a predetermined analysis target from the plurality of pieces of medical action information. More specifically, the singular point extraction unit 13 extracts information singular to the predetermined analysis target on the basis of action-specific frequencies of the execution details of records concerning the predetermined analysis target. Information which is extracted will be referred to as a singular point. That is, the singular point extraction unit 13 extracts a singular point of data stored in the action storage unit 12 by a statistical technique. “Singular point” is, for example, an action which is determined statistically significant (for example, too many or few) as compared with the frequencies of actions performed in an ordinary medical examination.

For example, the singular point extraction unit 13 extracts a singular point in the following sequence.

(1) The singular point extraction unit 13 determines an analysis target period. The singular point extraction unit 13 then determines a person for which analysis is to be performed. The determined person will be referred to as an object. An object may either be an instructor or an instructor group. An instructor group includes, for example, a hospital department, years of experience, or an instructor who issued instructions to a specific disease. It suffices to determine an object in advance or allow an object to be designated with a GUI or the like.

(2) The singular point extraction unit 13 determines an instruction item as an analysis target. The determined instruction item will be referred to as a target instruction item. It suffices to allow a target instruction item to be selected from the instruction items shown in FIG. 5 with a GUI or to determine a target instruction item in advance.

(3) The singular point extraction unit 13 obtains the frequency distribution (histogram) of the numbers of times of execution of different actions of execution details with respect to the target instruction item of a group belonging to the object. That is, the singular point extraction unit 13 counts the numbers of records associated with the object and the target instruction item for the different types of actions of the execution details. The singular point extraction unit 13 then obtains the frequency distribution of the numbers of times of execution of the different actions of the execution details with respect to the target instruction item of a group which does not belong to the object in the same manner. That is, the singular point extraction unit 13 counts the numbers of records associated with non-objects (persons for whom no analysis is performed) and the target instruction item for the different types of actions of the execution details.

(4) The singular point extraction unit 13 examines by comparison the difference between the frequency distributions of the two groups for each action of the execution details. As a comparative examination method, it suffices to use, for example, t-test based on average values, ANOVA analysis based on variance differences. The number of types of analyses to be performed need not be one but may be plural. If these analyses reveal a difference exceeding a predetermined value between the two groups, it is determined that there is a singular point, and the singular point is extracted. For example, an action of the execution details which exhibits a difference in frequency between the two groups is extracted as a singular point. The determination result is transmitted to the report creation unit 14.

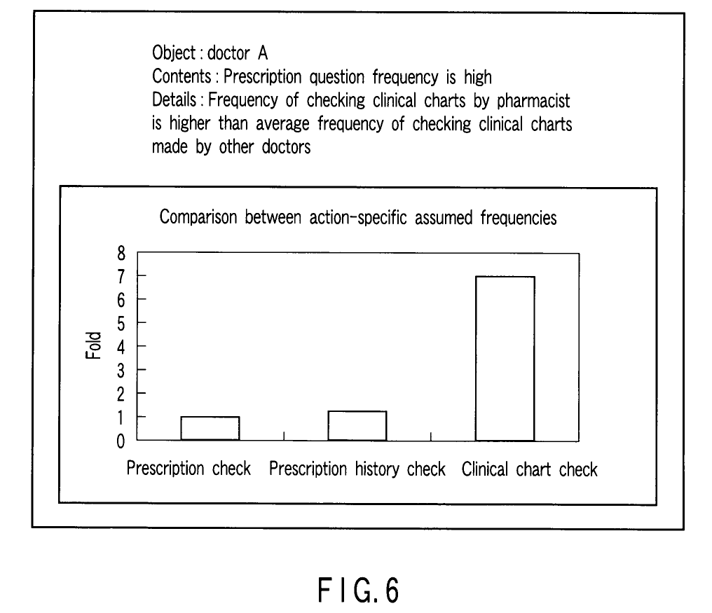

The report creation unit 14 creates a report (see, for example, FIG. 6) in accordance with a predetermined format. The report contains at least an analysis target (the object in FIG. 6) and an analysis result (the content in FIG. 6). The report may further contain more detailed analysis information (the details and graph in FIG. 6). The contents can be made easy to understand by creating display sentences by combining predetermined phrases on the basis of the analysis result. For example, the report shown in FIG. 6 indicates that the frequency with which pharmacists have checked clinical charts for the prescriptions made by a doctor A is higher than the average frequency with which pharmacists have checked the prescriptions made by other doctors. The action-specific assumed frequencies in FIG. 6 are assumed frequencies corresponding to the respective actions which are statistically obtained with respect to the respective instruction items before a singular point is extracted.

The report disclosure unit 15 transmits the report to predetermined medical professionals by electronic mail. It suffices to transmit electronic mail to, for example, the director of a hospital, a person in charge of a hospital department, and the like. It suffices to attach the report to electronic mail or only transmit the URL of a Web server which discloses the report.

According to the first embodiment, the action registration unit 11 registers, in the action storage unit 12, a plurality of records each containing information about the instructor of a medical action, an instruction from the instructor, an executor who has executed the action in accordance with an instruction item, and the action of the executor. The singular point extraction unit 13 counts the number of records, of the plurality of registered records, which are associated with a predetermined instructor and instruction for each type of action. The singular point extraction unit 13 statistically analyzes the counted number of records and extracts statistically significant information about the predetermined instructor and instruction. The report creation unit 14 creates a report about the extracted significant information.

### Second Embodiment

A medical safety system according to the second embodiment of the present invention will be described below. The arrangement of the medical safety system according to the second embodiment is the same as that according to the first embodiment. Note that the same reference numbers denote constituent elements having substantially the same functions as in the first embodiment, and a repetitive description will be made only when required.

The degree of abnormality corresponding to a given action of execution details in a series of medical processes varies in accordance with the time (medical status) at which the action is executed. For example, checking a clinical chart after the execution of an order is higher in the degree of question about prescription contents than checking the clinical chart at the time of execution of the order. However, the method of extracting a singular point on the basis of frequencies for the respective actions of execution details as in the first embodiment cannot give any consideration to the degree of abnormality corresponding to a medical status.

A singular point extraction unit 13 according to the second embodiment extracts the singular point of a predetermined analysis target by statistically analyzing a plurality of pieces of medical action information stored in an action storage unit 12 in consideration of the degree of abnormality. For this purpose, the singular point extraction unit 13 stores a score table which associates each action of execution details with a score representing the degree of abnormality of the action. The singular point extraction unit 13 extracts a singular point on the basis of a plurality of integrated values of scores associated with actions of a plurality of records associated with a predetermined analysis target on the score table.

FIG. 7 is a view showing an example of a score table. As shown in FIG. 7, a score has different values in accordance with medical statuses. For example, medical statuses are classified into “at time of execution of order”, “after execution of order”, “after accounting”, and “after surveillance” in chronological order. For example, the degree of abnormality corresponding to “clinical chart check” increases with the progress of stages, the score increases as the medical status progresses. Referring to FIG. 7, the score “20” is associated with the action “clinical chart check” of the execution details which is performed at the time of the execution of the order; the score “40”, with “clinical chart check” performed after the execution of the order; the score “80”, with “clinical chart check” performed after accounting; and the score “100”, with “clinical chart check” performed after surveillance.

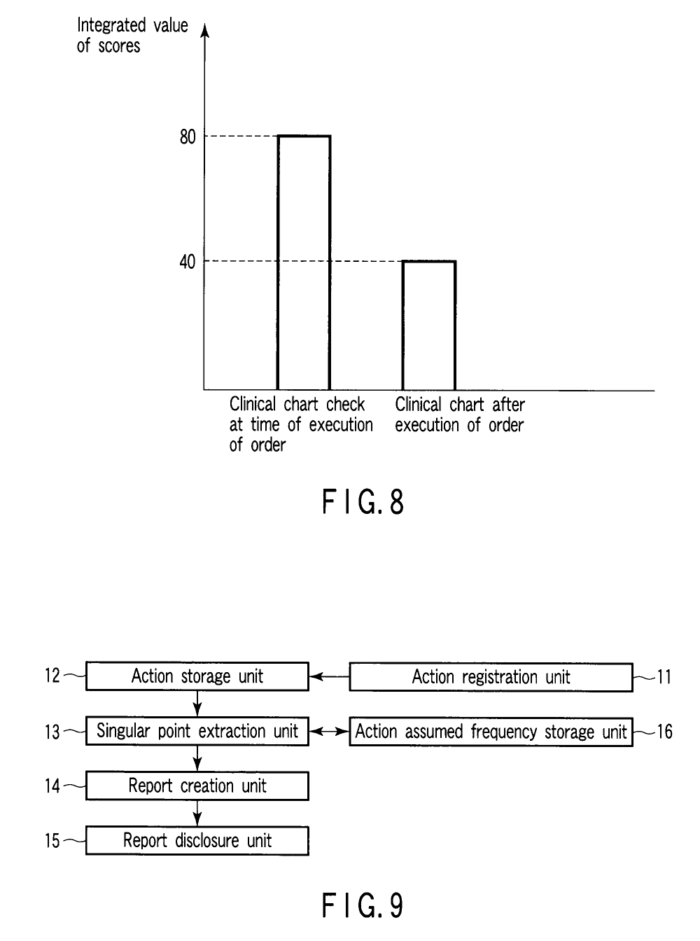

FIG. 8 shows the integrated values of scores obtained when a clinical chart check at the time of the execution of the order and a clinical chart check after the execution of the order are each made twice. Note that the scores in FIG. 8 are the same as those in FIG. 7. That is, the score “20” is obtained when “clinical chart check during execution of order” is performed once, and the score “40” is obtained when “clinical chart check after execution of order” is performed once. As shown in FIG. 8, changing the score in accordance with the difference between medical statuses can assign a frequency with a weight changing in accordance with the medical statuses.

In the second embodiment, the singular point extraction unit 13 extracts a singular point in, for example, the following sequence. Note that steps (1) and (2) are the same as those in the extraction processing in the first embodiment, and hence will be briefly described below.
(1) The singular point extraction unit 13 determines a target period. The singular point extraction unit 13 then determines an object.
(2) The singular point extraction unit 13 determines a target instruction item.
(3) The singular point extraction unit 13 integrates the scores of actions of the execution details of records associated with the object and the target instruction item for the respective actions of the execution details. The singular point extraction unit 13 then refers to the score table and integrates the scores of the actions of the execution details of the records associated non-object and the target instruction item for the respective actions of the execution details.
(4) The singular point extraction unit 13 examines by comparison the difference between the distributions of the integrated values of the scores of the two groups for each action of the execution details. As a comparative examination method, it suffices to use, for example, t-test or ANOVA analysis. An analysis to be executed is not limited to one, but can be plural. If these analyses reveal a difference exceeding a predetermined value between the two groups, it is determined that there is a singular point, and the singular point is extracted. For example, an action of the execution details which exhibits a difference in integrated value between the two groups is extracted as a singular point.

When a singular point is extracted, a report creation unit 14 creates a report as in the first embodiment. A report disclosure unit 15 discloses the created report.

Note that the method of extracting a singular point by using the integrated values of scores is not limited to the above method. For example, the integrated value of scores is compared with a predetermined threshold. If the integrated value exceeds the threshold, associated medical action information can be extracted as a singular point.

The following is a sequence of singular point extraction processing based on comparison between integrated values and a threshold. Note that steps (1) and (2) are the same as those in the above extraction processing sequence, and hence will be briefly described.
(1) The singular point extraction unit 13 determines a target period. The singular point extraction unit 13 then determines an object.
(2) The singular point extraction unit 13 determines a target instruction item.
(3) The singular point extraction unit 13 integrates the scores of actions of the execution details of medical action information concerning the object and the target instruction item for the respective actions of the execution details with reference to the score table.
(4) If the integrated value corresponding to any of the actions of the execution details exceeds a predetermined threshold, the singular point extraction unit 13 extracts the action of the execution details which corresponds to a record having the integrated value exceeding the threshold. The extracted action is processed as a singular point by the singular point extraction unit 13. The determination result is transmitted to the report creation unit 14.

This singular point extraction processing based on the comparison between integrated values and a threshold requires a much smaller number of data samples than extraction processing based on frequencies as long as scores and a threshold are properly set. Assume that a clinical chart check after the execution of an order is an action which should not be done at all in terms of actual operation. In this case, the score assigned to a clinical chart check after the execution of an order is set to be much higher than the scores assigned to clinical chart checks in the other medical statuses, and a threshold is set to a value approximate to the score assigned to a clinical chart check after the execution of an order. For example, in the score table in FIG. 7, the score assigned to a clinical chart check after the execution of an order is set to “1000”, and the threshold for a clinical chart check is also set to “1000”. When the singular point extraction unit 13 performs extraction processing with this set value, the singular point extraction unit 13 extracts a singular point associated with a clinical chart check after the execution of an order at the time point when the clinical chart check is made after the execution of the order. When a singular point is extracted, the report creation unit 14 immediately creates a report. The report disclosure unit 15 then discloses that a clinical chart check has been made after the execution of an order.

According to the second embodiment, an action registration unit 11 registers, in the action storage unit 12, a plurality of records each containing information about an instructor of a medical action, an instruction from the instructor, an executor who has executed an action in accordance with an instruction item, and the action of the executor. The singular point extraction unit 13 stores a score table which associates the action of an executor with a score indicating the degree of abnormality of the action. The singular point extraction unit 13 integrates a plurality of scores associated with a plurality of actions of records, of the plurality of registered records, which concern a predetermined instructor and instruction, on the score table, for each type of action, thus calculating a plurality of integrated values. The singular point extraction unit 13 statistically analyzes the plurality of calculated integrated values, and extracts statistically significant information about the predetermined instructor and instruction. The report creation unit 14 creates a report about the extracted significant information.

### Third Embodiment

FIG. 9 is a block diagram showing the schematic arrangement of a medical safety system according to the third embodiment of the present invention. The same reference numbers as in FIG. 4 denote the same parts in FIG. 9, and a detailed description thereof will be omitted. A singular point extraction unit 13 according to the third embodiment can execute both extraction processing based on frequencies and extraction processing based on scores. Assume that the singular point extraction unit 13 performs extraction processing based on frequencies for a concrete description below.

As shown in FIG. 9, the medical safety system according to the third embodiment further comprises an action assumed frequency storage unit 16. The action assumed frequency storage unit 16 stores assumed frequencies set for “instruction item”, “executed action”, and “execution details”. FIG. 8 shows an example of assumed frequencies stored in the action assumed frequency storage unit 16.

In general, it is often possible to predict execution details executed by an executor. For example, when a prescription instruction is issued, the prescription window shown in FIG. 2 is displayed. An executor therefore checks a prescription and a prescription history, but does not generally perform clinical chart reference which is executed with another button. The executor performs clinical chart reference when he/she has a question about the prescription contents. As described above, the execution details executed by an executor in response to an instruction item can be predicted, and hence the predicted operation frequency is stored as an assumed frequency in advance. In the example shown in FIG. 10, assumed frequencies are classified into two levels, namely levels “A” and “B”. Level “A” is defined as a level indicating that clinical chart reference is generally executed (70 or more number of times of execution out of 100 times of action), and level “B” is defined as a level indicating that clinical chart reference is not generally executed (69 or less number of times of execution out of 100 times of action). Note that assumed frequencies can be classified into three or more levels. Alternatively, the ratios between the numbers of times of execution for execution details can be directly registered as assumed frequencies.

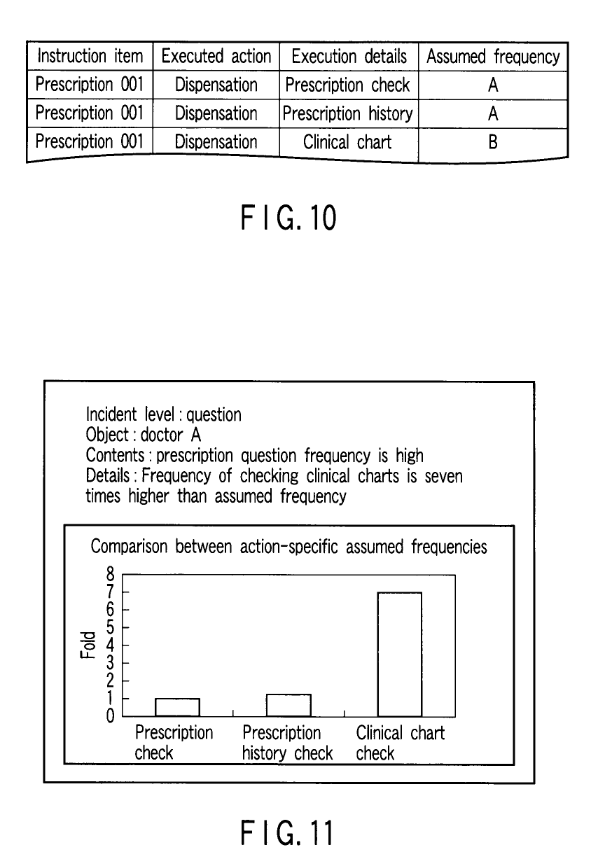

First of all, the singular point extraction unit 13 obtains the frequency distribution of action-specific execution times of execution details with respect to an analysis target instruction time of a group belonging to an analysis target by the same method as that in the first embodiment. The singular point extraction unit 13 compares the obtained frequency distribution with the assumed frequencies stored in the action assumed frequency storage unit 16. It suffices to perform analysis by using, for example, t-test which is a test method using average values. Alternatively, an analysis may be simply made to determine whether any action has been executed with a frequency exceeding an assumed frequency as a threshold. If any difference is recognized as a result of analysis, a report creation unit 14 creates a report as in the first embodiment. A report disclosure unit 15 then discloses the created report. FIG. 11 shows an example of a report in this case. As shown in FIG. 11, using assumed frequencies can create a report with higher accuracy.

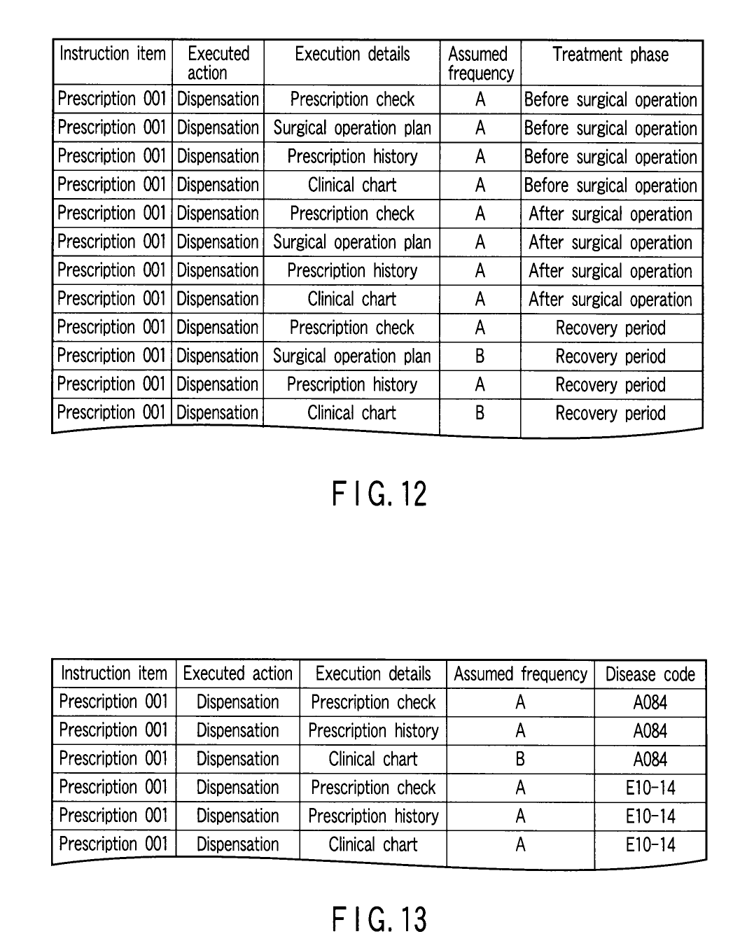

Note that the accuracy can be further increased by defining assumed frequencies in correspondence with treatment phases and disease codes. FIG. 12 shows a case in which assumed frequencies have treatment phases. FIG. 13 shows a case in which assumed frequencies have disease codes.

As shown in FIG. 12, in a case in which action assumed frequencies have treatment phases, when, for example, prescription instructions are issued before and after operation, an operation plan check and a clinical chart check are performed as normal operations. In contrast, when a prescription instruction is issued in a recovery period, an operation plan check and a clinical chart check are not performed as normal operations. Obviously, a clinical chart check is performed as normal operation after operation, but is not performed as general operation in a recovery period.

Assume that action assumed frequencies have disease codes, as shown in FIG. 13. In the case of viral enteral infection disease (A084), no clinical chart reference is performed in general (i.e., the assumed frequency “B”). In the case of diabetes (E10 to E14), a clinical chart is often referred to check the progress of diabetes. For this reason, the assumed frequency corresponding to clinical chart reference in the case of this disease is set to “A”. Diseases or disease groups can be associated with assumed frequencies in this manner. Obviously, it suffices to consider both disease codes or disease group codes and the treatment phases of patients.

### Fourth Embodiment

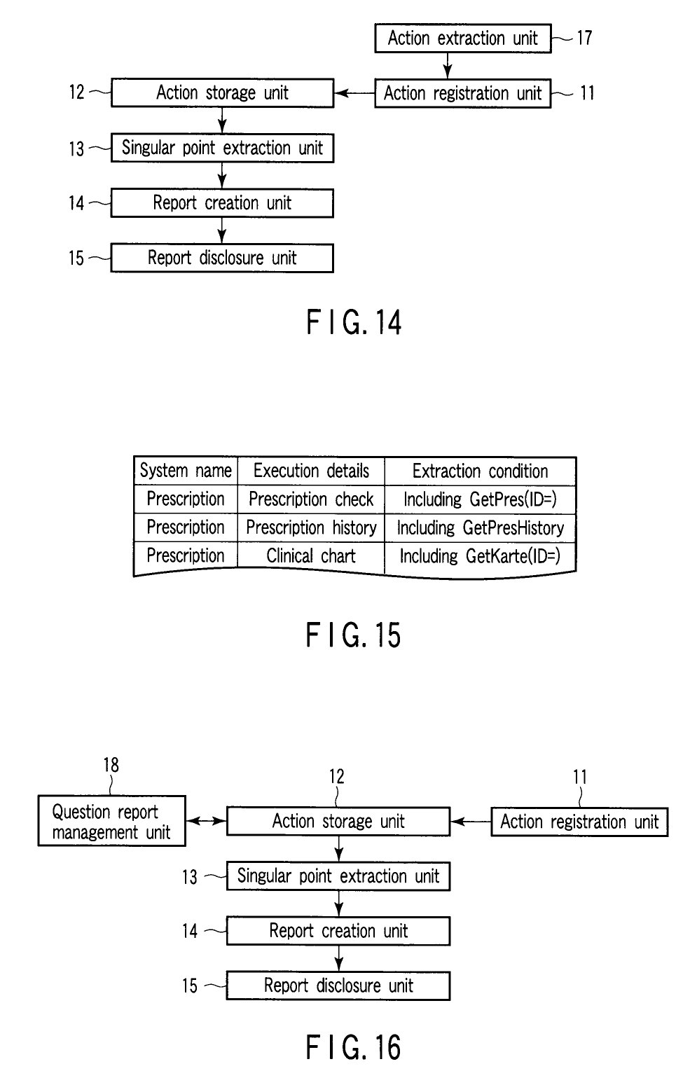

FIG. 14 is a block diagram showing the schematic arrangement of a medical safety system according to the fourth embodiment of the present invention. The same reference numbers as in FIG. 4 denote the same parts in FIG. 14, and a detailed description thereof will be omitted. A singular point extraction unit 13 according to the fourth embodiment can execute both extraction processing based on frequencies and extraction processing based on scores. In order to make a detailed description, assume that the singular point extraction unit 13 performs extraction processing based on frequencies for a concrete description below.

As shown in FIG. 14, the medical safety system according to the fourth embodiment further comprises an action extraction unit 17. The action extraction unit 17 comprises an action extraction condition table like that shown in FIG. 15. The action extraction unit 17 extracts an action defined in the action extraction condition table from an operation log (log file). The action extraction unit 17 extracts an action from the operation log from each information system on the basis of the contents of the action extraction condition table. The extracted action is transmitted to an action registration unit 11 and stored in the action storage unit 12. The subsequent sequence is the same as that in the first embodiment. The action extraction unit 17 may perform processing by acquiring operation log information from each type of medical information system via a network or may acquire only a processing result from each type of medical information system.

In the action extraction condition table shown in FIG. 15, words as keywords are simply registered in advance. However, it suffices to extract an action with a combination of a plurality of keywords. This can further improve the accuracy. A recent medical information system often incorporates a surveillance system which records who has performed which operation for what data at what time. In this case, using information obtained by the surveillance system makes it possible to extract an action more easily. In this case as well, it suffices to store, in advance, conditions for the acquisition of information from the surveillance system in the action extraction condition table shown in FIG. 15. In the action extraction condition table shown in FIG. 15, execution details have a one-to-one relationship with extraction conditions. Obviously, even if they have a one-to-n relationship, the action extraction condition table shown in FIG. 15 can be used. Note that the action extraction described above may be performed at predetermined time intervals.

### Fifth Embodiment

FIG. 16 is a block diagram showing the schematic arrangement of a medical safety system according to the fifth embodiment of the present invention. The same reference numbers as in FIG. 4 denote the same parts in FIG. 16, and a detailed description thereof will be omitted. Note that a singular point extraction unit 13 according to the fifth embodiment can execute both extraction processing based on frequencies and extraction processing based on scores. In order to make a detailed description, assume that the singular point extraction unit 13 performs extraction processing based on frequencies for a concrete description below.

As shown in FIG. 16, the medical safety system according to the fifth embodiment further comprises a question report management unit 18. The question report management unit 18 comprises at least a function of performing transmission, recording, and management of question reports and management of a transmission log. Note that an action storage unit 12 can store a transmission log as a kind of action executed in response to an instruction. The analysis method to be used is the same as that in each embodiment described above, and hence a description of the method will be omitted.

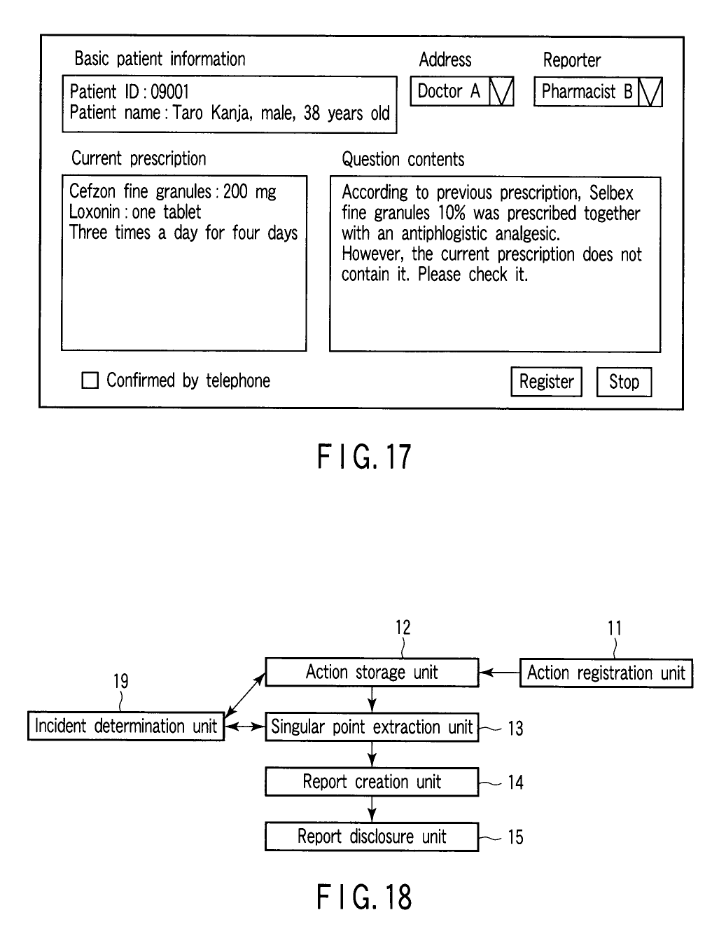

FIG. 17 is a view showing a question report window example. An executor creates a question report when he/she has a question about an instruction from an instructor. This question report window comprises, for example, a patient information area, an address/sender information area, a current prescription area, a question content area, and a telephone confirmed button. The executor selects an address and a reporter from a list. In the current prescription area, current prescription contents are automatically set. In the question content area, the executor writes a question content. Upon writing the question content, the executor presses the registration button. When the registration button is pressed, a question report is transmitted to the instructor at the address. It suffices to transmit the contents of the window upon attaching them as an attached file to electronic mail or to transmit only the URL of the window by electronic mail. In an emergency, the executor may make a check by telephone. In such a case, the executor places a checkmark on the telephone confirmed button and presses the registration button to leave a question generation record. In this case, since the instructor has already known the question content, the question report management unit 18 may leave only the question generation record in the action storage unit 12 without transmitting any question report to the instructor. Upon receiving the question report, the instructor replies to the content. Although a reply window will not be illustrated, the instructor inputs a reply in the reply area while referring to the question content. The instructor then replies by pressing the reply registration button.

### Sixth Embodiment

FIG. 18 is a block diagram showing the schematic arrangement of a medical safety system according to the sixth embodiment of the present invention. The same reference numbers as in FIG. 4 denote the same parts in FIG. 18, and a detailed description thereof will be omitted. A singular point extraction unit 13 according to the sixth embodiment can execute both extraction processing based on frequencies and extraction processing based on scores. In order to make a detailed description, assume that the singular point extraction unit 13 performs extraction processing based on frequencies for a concrete description below.

As shown in FIG. 18, the medical safety system according to the sixth embodiment further comprises an incident determination unit 19. The incident determination unit 19 has a function of determining, as an incident, a case in which a previously issued instruction is changed by a question inquiry. In order to perform incident determination, the incident determination unit 19 extracts a question inquiry from an action storage unit 12 and also extracts an instruction associated with the question inquiry. To facilitate these operations, the action storage unit 12 can hold, in the action frequency table shown in FIG. 5, instruction identification information which uniquely identifies an instruction and instruction-related identification information which indicates a relation with the instruction as new items. If it is determined in this manner that the instruction has been updated, the case is determined as an incident and stored. The incident determination unit 19 also notifies the singular point extraction unit 13 of information about the incident. The singular point extraction unit 13 stores the notified incident. The stored incident can be read out and processed as one singular point by the singular point extraction unit 13. The report creation unit 14 creates a corresponding report in the basis of the singular point. The created report can then be transmitted to the report disclosure unit 15. The transmitted report can then be disclosed by the report disclosure unit 15.

The sixth embodiment has exemplified the case in which only the incident determination unit 19 is added to the arrangement of the first embodiment. Using the question report management unit 18 in the fifth embodiment in combination with the above arrangement can further improve the likelihood. In the third to sixth embodiments, the action assumed frequency storage unit 16, the action extraction unit 17, the question report management unit 18, and incident determination unit 19 which are different constituent elements have been described independently of each other. However, these action elements can be properly combined and used. For example, as described above, the question report management unit 18 and the incident determination unit 19 can be combined. In addition, for example, the action assumed frequency storage unit 16, the action extraction unit 17, and other units, or all the units can be combined.

As has been described above, according to the embodiments of the present invention, it can be expected to comprehensively evaluate an unsafe status in an organization or a specific individual by cross-analyzing the respective types of information systems. Enabling such evaluation makes it possible to find an event which causes a medical accident, before the actual occurrence of a medical accident, thereby preventing the occurrence of a medical accident.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A medical safety system comprising:
a first storage unit which stores medical action information including at least information about an instructor of a medical action, an instruction from the instructor, an executor who has executed an action in accordance with the instruction, and the action executed by the executor;
a first extraction unit which extracts information singular to a predetermined analysis target of the medical action information by statistically analyzing the predetermined analysis target; and
a creation unit which creates a report including at least an analysis result and the analysis target on the basis of the extracted singular information.

2. The system according to claim 1, wherein
the first storage unit stores the medical action information as a plurality of records each including at least information about the instructor, the instruction, the executor, and the action, and
the first extraction unit extracts the singular information on the basis of frequencies of a plurality of records concerning the analysis target for the respective actions.

3. The system according to claim 1, wherein
the first storage unit stores the medical action information as a plurality of records each including at least information about the instructor, the instruction, the executor, and the action, and
the first extraction unit stores a score table which associates the action with a score indicating a degree of abnormality of the action, and extracts the singular information on the basis of integrated values of a plurality of scores associated with actions of a plurality of records concerning the analysis target on the score table.

4. The system according to claim 3, wherein the first extraction unit extracts an action of a record concerning an integrated value exceeding a predetermined threshold as the singular information.

5. The system according to claim 1, wherein the creation unit creates the report which includes information about the instructor who has issued an instruction which is a cause of the singular information.

6. The system according to claim 1, which further comprises a second storage unit which stores, as an assumed frequency, a frequency of an action which is assumed to be executed by the executor in response to an instruction from the instructor, and in which
the first extraction unit extracts information corresponding to a frequency exceeding the assumed frequency as singular information.

7. The system according to claim 6, wherein the second storage unit stores the assumed frequency in association with at least one of a treatment phase and a disease code which classifies a disease.

8. The system according to claim 1, further comprising a second extraction unit which extracts a desired action from an operation log in each system connected to the medical safety system via a network.

9. The system according to claim 8, wherein the first storage unit stores an action extracted by the second extraction unit.

10. The system according to claim 1, further comprising a management unit which, when the executor generates a question about an instruction from the instructor, manages a question report including information about the question generated by the executor.

11. The system according to claim 10, wherein
the management unit transmits the question report to the instructor, and
the first storage unit further stores a transmission log which indicates that the question report has been transmitted to the instructor.

12. The system according to claim 1, further comprising a determination unit which, when a content of an instruction from the instructor is changed by a question, determines the change as an incident.

13. The system according to claim 12, wherein
the determination unit notifies the first extraction unit of the determined incident, and
the first extraction unit processes the notified incident as one piece of the singular information.

14. A medical safety system comprising:
an input unit which inputs a plurality of records each including information about an instructor of a medical action, an instruction from the instructor, an executor who has executed an action in accordance with the instruction, and the action executed by the executor;
a counting unit which counts the number of records, of the plurality of input records, which concern a predetermined instructor and a predetermined instruction, for each type of the action;
an extraction unit which extracts statistically significant information about the predetermined instructor and the predetermined instruction by statistically analyzing the counted number of records; and
a creation unit which creates a report concerning the extracted significant information.

15. A medical safety system comprising:
an input unit which inputs a plurality of records each including information about an instructor of a medical action, an instruction from the instructor, an executor who has executed an action in accordance with the instruction, and the action executed by the executor;
a storage unit which stores a score table which associates an action of an executor with a score indicating a degree of abnormality of the action;
a calculation unit which calculates a plurality of integrated values by integrating a plurality of scores associated with actions of a plurality of records, of the plurality of input records, which concern a predetermined instructor and a predetermined instruction, on the score table, for the respective types of actions;
an extraction unit which extracts statistically significant information about the predetermined instructor and the predetermined instruction by statistically analyzing the plurality of calculated integrated values; and
a creation unit which creates a report concerning the extracted significant information.
